(19) United States
(12) Patent Application Publication
(10) Pub. No.: US 2010/0169161 A1
(43) Pub. Date: Jul. 1, 2010

(54) TRANSACTION INFORMATION BASED SOCIAL GROUPS

(75) Inventor: Nathan Sacco, San Jose, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., SAN JOSE, CA (US)

(21) Appl. No.: 12/347,918

(22) Filed: Dec. 31, 2008

(51) Int. Cl. G06Q 99/00; G06F 3/048; G06F 15/16; G06Q 10/00; G06Q 50/00

(52) U.S. Cl. 705/10; 715/733; 705/319; 705/14.66

(57) ABSTRACT

A computerized method and system for initiating a social group based on historical transaction information are provided. Example embodiments may include creating a user interface associated with a social network, and automatically suggesting, via the user interface, formation of a group within the social network, based on historical transaction information. A response may be received from one or more users, via the user interface. The response may indicate that the one or more users are interested in the group. In response to receiving the response, a group data structure may be created automatically.

### TECHNICAL FIELD

Example embodiments relate generally to the technical field of data management, and in one specific example, to a system and a method for initiating a social group based on historical transaction information.

### BACKGROUND

Networks may be viewed, in an abstract way, as having a plurality of nodes connected via a number of links that define the relationship between the nodes. Specifically, in social networks (e.g., Facebook.com, mySpace.com, or Linkedin.com) the nodes may represent people and the links between the nodes may represent social relationships of different types, such as, family member, friend, school mate, teammate, co-worker, etc.

Each person may be a member of several networks, such as networks of graduates of a certain school at a certain year, or employees of a business entity, or members of a team, etc. Networks may be connected through common members. Network members may share information as they desire or make their information available to other members of one or more networks.

### BRIEF DESCRIPTION OF THE DRAWINGS

Some embodiments are illustrated by way of example and not limitation in the figures of the accompanying drawings in which:

FIG. 1 is a high-level diagram depicting, in an example embodiment, functionality of a system for initiating a social group based on historical transaction information;

FIG. 2 is a block diagram illustrating an example embodiment of a system for initiating a social group based on historical transaction information;

FIG. 3 is a block diagram illustrating, in an example embodiment, components of a client system used in FIG. 2;

FIG. 4 is a high-level flow diagram illustrating an example method for initiating a social group based on historical transaction information;

FIG. 5 is high-level block diagram illustrating an example embodiment of a network-based publication system, having a client-server architecture, initiating a social group based on historical transaction information;

FIG. 6 is an example set of publication and social network applications used by the network-based publication system of FIG. 5;

FIG. 7 is an example set of social network applications used by the network-based publication system of FIG. 5;

FIG. 8 is database schema illustrating, in an example embodiment, various tables of a social network data structure;

FIG. 9 is a diagram illustrating a diagrammatic representation of a machine in the example form of a computer system;

FIG. 10 is a screen shot illustrating an example embodiment of a user interface used for initiating a social group based on historical transaction information; and

FIG. 11 is a screen shot illustrating an example embodiment of a user interface showing the home page of a social group initiated based on historical transaction information.

### DETAILED DESCRIPTION

Example methods and systems for initiating a social group based on historical transaction information will be described. In the following description, for purposes of explanation, numerous specific details are set forth in order to provide a thorough understanding of example embodiments. However, it will be evident to one skilled in the art that the present subject matter may be practiced without these specific details.

Some example embodiments described herein may include creating a user interface associated with a social network (e.g., Facebook.com, mySpace.com, or Linkedin.com) and automatically suggesting, via the user interface, formation of a group (e.g., a neighborhood) within the social network, based on historical transaction information (e.g., information related to listings in a commerce system, such as number of sold listings, number of bids placed for each listing, feedbacks, etc.). Distinctions of the subject matter presented herein with respect to existing art include the fact that, in the art, formation of groups are not automatic, rather they are initiated by participants in an already existing electronic social network or agents of publication systems, commerce systems, etc.

A response may be received from one or more users, via the user interface. The response may indicate that the one or more users are interested in the group. In response to receiving the response, a group data structure may be created automatically. Information related to the group may be received from users and stored in the group data structure.

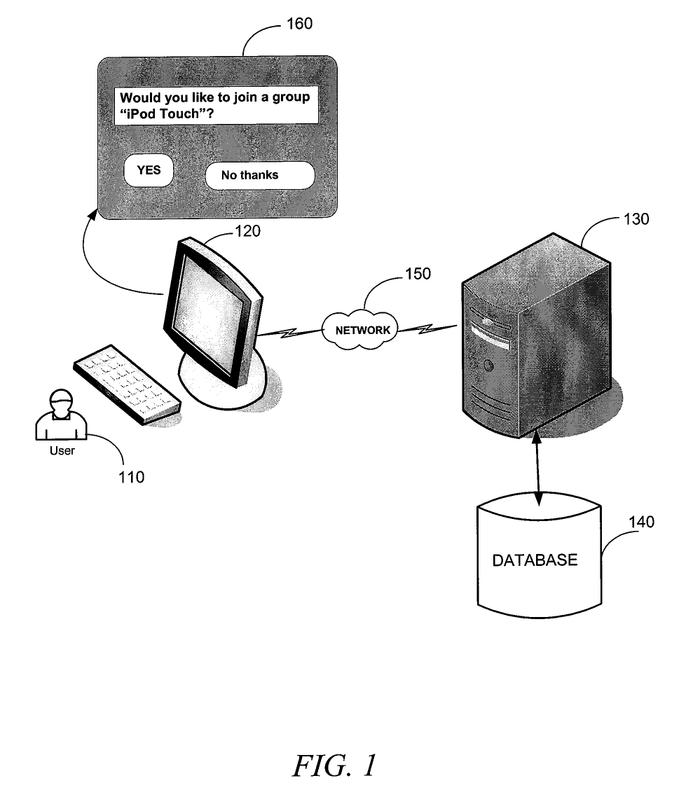

FIG. 1 is a high-level diagram depicting, in an example embodiment, functionality of a system for initiating a social group based on historical transaction information. A social network server 130 associated with an online publication system (e.g., eBay Inc. or Kijiji.com) may create one or more user interfaces 160 associated with one or more social networks (e.g., a social network sponsored by the online publication system) and automatically suggest formation of a number of groups to a user 110 of a client system 120. It should be emphasized that the suggestion to form a new group is automatic; it is not initiated by a person. Instead, the server 130, as discussed in detail below, may take the initiative and pursue the creation of the new group.

The client system 120 maybe linked to the social network server 130 via the network 150 (e.g., the Internet). The server 130, in suggesting the formation of the new group (e.g., a suggested group) may use historical transaction information stored in database 140. The historical transaction information may include information related to one or more listings in the online publication system. The historical transaction information may, for example, include a number of popularity factors associated with the listings in the online publication system. The popularity factor related to the one or more listings may include a number of bids for an item, a number of completed transactions, or feedback. For example, if the social network server 130 determines that a group of items related to a category are highly popular, i.e. receive a large number of bids or are sold in large numbers or quantities, the social network server 130 may propose formation of a group related to that category.

In the example embodiment shown in FIG. 1, the user interface 160 displayed on the client system 120 suggests formation of a group related to a popular item “iPod Touch” and invites the user 110 to join the group. In an example embodiment, the user 110 may respond to the invitation from the social network server 130, using the user interface 160. In an example embodiment, the social network server 130 may communicate a message (e.g., an electronic message, such as email, text message, or voice mail) to the user 110 and invite the user 110 to join the new group. The user 110 may also use other means of communication with the social network server 130 (e.g., email, text message, etc.) to communicate a response to the invitation to join the group.

In response to receiving the response, the social network server 130 may automatically create a group data structure. The group data structure may be stored in the database 140 and may include data related to the group (e.g., group data). The group data may include data feeds including information related to one or more activities associated with a group member. The data feed may include, for example, a suggestion by one or more group members, or a shopping or trading story shared by a number of group members. The suggestion by the group members may relate to formation of a new group or inviting a new group member to join an existing group.

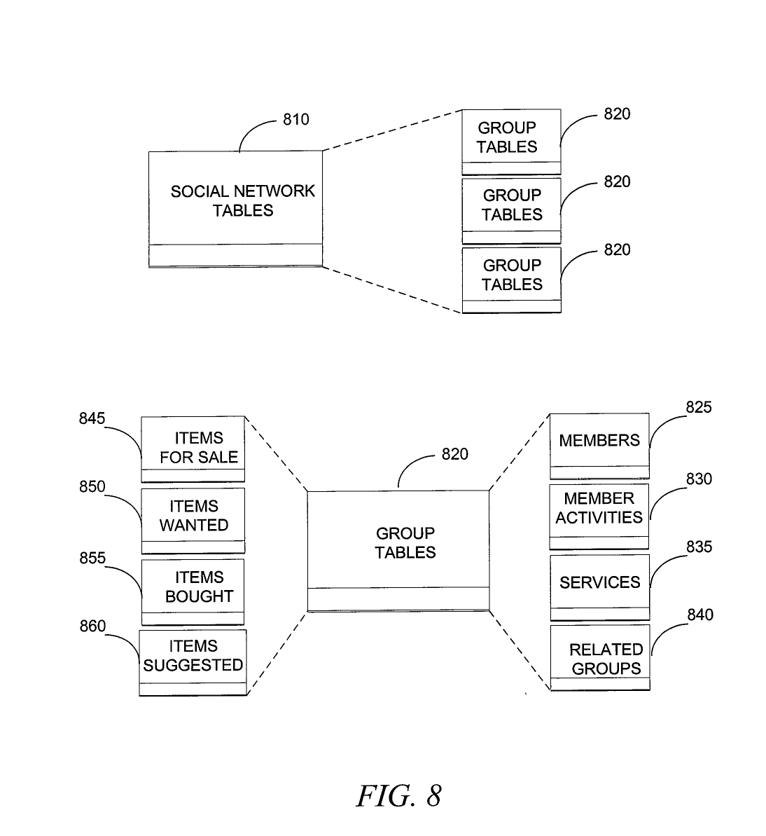

In some example embodiments, the social network server 130 may receive information related to the group from the user 110 (e.g., the group member) and store the information in the group data structure (see, for example, FIG. 8). The group member may provide his/her identification information (e.g., name, telephone number, email address, etc.), information related to the activities by the group member, listings (e.g., items) sold or purchased or on sale by the group member (e.g., using the online publication system), group member's listings of interest (e.g., wanted listings), listings (e.g., services or items) suggested by the group member, or promotional or advertisement materials.

The group data may also include group members' identification data. For example, the social network server 130 may include a member directory in the group data structure. The group directory may include group members' identification information. The social network server 130 may facilitate group members sharing other information such as membership in other groups or networks. The social network server 130 may present the group data including the information received from group members to users (e.g., group members or guests). A list of group services (e.g., by services provided by certain group members, such as, but not limited to, professional or volunteer services) may be posted in a website associated with the group (e.g., group website). The social network server 130 may also post promotional or advertisement material related to the group in the group website.

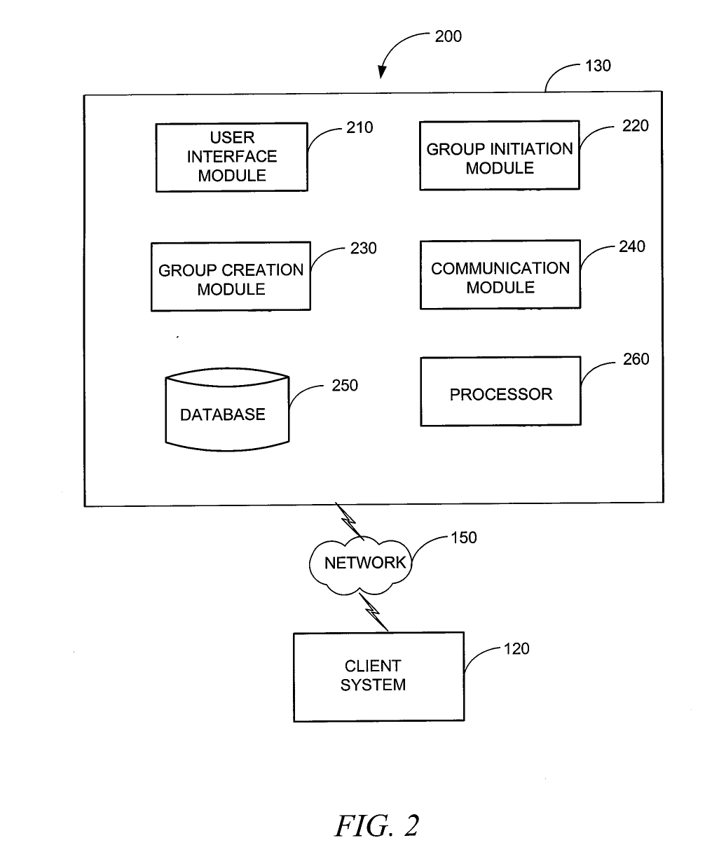

FIG. 2 is a block diagram illustrating an example embodiment of a system 200 for initiating a social group based on historical transaction information. The system 200 may include the social network server 130 and the client system 120. The social network server 130 may include a user interface module 210, a group initiation module 220, a group creation module 230, a communication module 240, a database 250, and a processor 260. These modules may be implemented by hardware, software or a combination of hardware and software. The social network server 130 may be linked to client system 120 via the network 150 (e.g., the internet).

The user interface module 210 may create a number of user interfaces (e.g., user interface 160) associated with a social network. One or more of the user interfaces may be used by the group initiation module 220 to automatically suggest formation of a group within the social network, based on historical transaction information. According to example embodiments, the historical transaction information may include information related to a listing (e.g., an item or a service) listed in an online publication system (e.g., eBay Inc. or Kijiji.com). The historical transaction information may also include a popularity factor associated with the listing in the online publication system.

The popularity factor may be determined by the processor 260. The processor 260 may determine the popularity factor using data related to listings in the online publication system retrieved from the database 250. The data related to listings may include counts of the number of bids placed by bidders for the listings, counts of the number of completed transactions associated with the listings, feedback pertaining to the listings, received from various parties (e.g., including parties to the completed or incomplete transactions), or counts of a number of views received by the listings, a number of searches associated with the listings, or a number of people expressing interest in the listings (e.g., watching the listings).

The processor 260 may implement an algorithm for determining the popularity factor. For example, the processor 260 may assign different weighting factors to various data related to a listing and combine the weighted factors to arrive at a popularity factor for that listing. The processor 260 may create a ranked list of listings based on the popularity factor. The group initiation module 220 may use the ranked list to decide about initiating a new group. In an example embodiment, the group initiation module 220 may decide to form new groups related to the top 10% of the listings in the ranked list. Similarly, the processor 260 may provide a ranked list of categories of listings and group initiation module 220 may initiate formation of new groups based on some high ranking categories (e.g., cars, books, antiques, music, home and garden, etc.).

Alternatively, the group initiation module 220 may decide to initiate a new group related to a popular seller's interests or activities. For example, an identification of a certain art (e.g., music) associated with a popular seller who is known for his talent in that art may be a good candidate for formation of a new group using that identification. Fans of a popular person may also be interested in joining groups formed around the popular person's items of interest.

The communication module 240 may, in an example embodiment, communicate a message to the users inviting the users to join the new group. The communication module 240 may communicate the message using the user interfaces provided by the user interface module 210. Alternatively, the communication module may use other communication means such as, but not limited to, email, voicemail, or text message to invite the user to join the new group.

Following the initiation of a new group and invitations communicated to the users, the communication module 240 may receive responses from one or more users indicating interest in the new group. The responses may be passed to the group creation module 230, which may automatically create a group data structure (for an example data structure, see FIG. 8) that includes group data. The group creation module may decide to abandon the formation of the new group if the number of responses from interested users is below a predetermined threshold (e.g., 10). The group data structure may be stored in the database 250. According to an example embodiment, the group data may includes data feeds including data related to activities associated with one or more group members. The user interface module 210 may provide user interfaces to provide member alerts advising the users with respect to activities associated with the group members.

The data feeds, in other example embodiments, may include suggestions by one or more group members, including the formation of a new group or inviting new group members to the new group. The data feeds may also include shopping or trading stories shared by one or more group members. The user interface module may provide user interfaces presenting group data to the users. For example, the user interfaces may allocate portions of displayed pages to describing group members activities or interests, group services provided by the group members (e.g., professional or volunteer services), items on sale, sold, or purchased by the group members (e.g., using the online publication system, such as eBay inc. or Kijiji.com), or items wanted or suggested by the group members. The user interfaces may also display a group member directory including identifications of the group members.

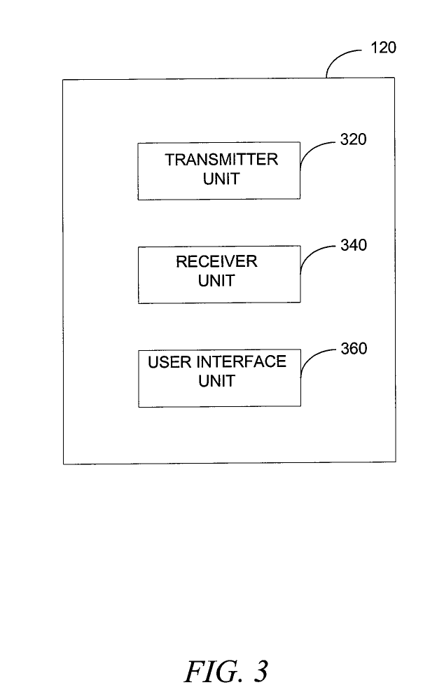

FIG. 3 is a block diagram illustrating, in an example embodiment, components of a client system 120 used in FIG. 2. The client system 120 may include a transmitter unit 320, a receiver unit 340, and a user interface unit 360. The receiver unit 340 may receive a user interface associated with a social network from the social network server 130 (see FIG. 1). The user interface (e.g., user interface 160 of FIG. 1) may automatically suggest formation of a group within the social network based on historical transaction information (e.g., information related to listings or popularity factors associated with listings in an online publication system). The user interface unit 360 may present the user interface to users of the client system.

The transmitter unit 320 may transmit responses from one or more users indicating that the users are interested in joining the group. Following to the transmitting of the response, the receiver unit 340 may receive a notification indicating formation of the group. The receiver unit 340 may also receive, from the social network server 130 (see FIG. 1) a request for group data (e.g., data feeds). The transmitter unit 320 may transmit data feeds provided by the users (e.g., information related to an activity associated with users such as group members).

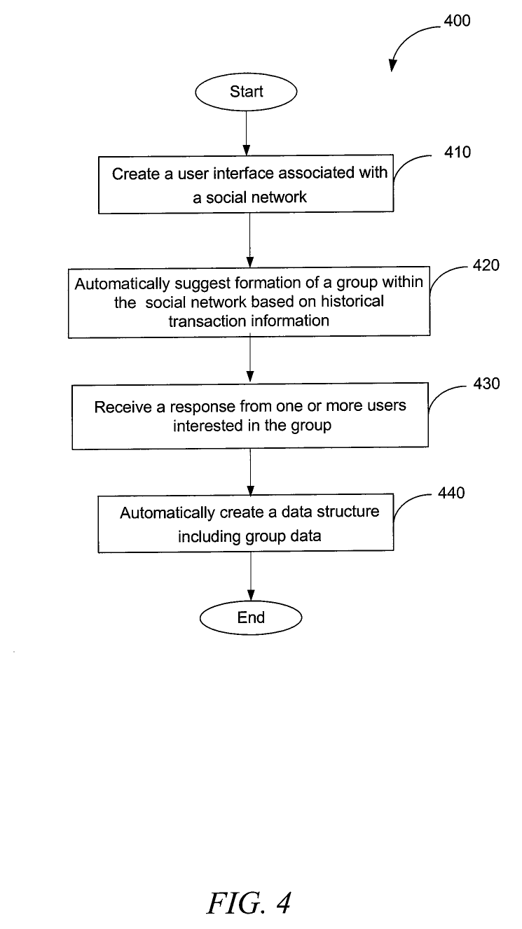

FIG. 4 is a high-level flow diagram illustrating an example method 400 for initiating a social group based on historical transaction information. At operation 410, the user interface module 210 (see FIG. 2) may create a user interface (e.g., the user interface 160 of FIG. 1) associated with a social network. The group initiation module 220 (see FIG. 2) may, at operation 420, automatically suggest formation of a group within the social network based on historical transaction information (e.g., information related to listings or popularity factors associated with listings in an online publication system). The group initiation module 220, in determining the popularity factor, may use services of the processor 260 (see FIG. 2) as described above. At operation 430, the communication module 240 (see FIG. 2) may receive responses from one or more users indicating that the users are interested in the group.

In response to receiving the responses, the group creation module 230 (see FIG. 2) may automatically create a data structure (at operation 440). The data structure may include group data received from users (e.g., group members). The group data may, for example, include data feeds such as information related to an activity associated with users such as group members. The data structure may be stored in the database 250. The data structure stored in the database 250 may include database schema as discussed below, in the description of FIG. 8.

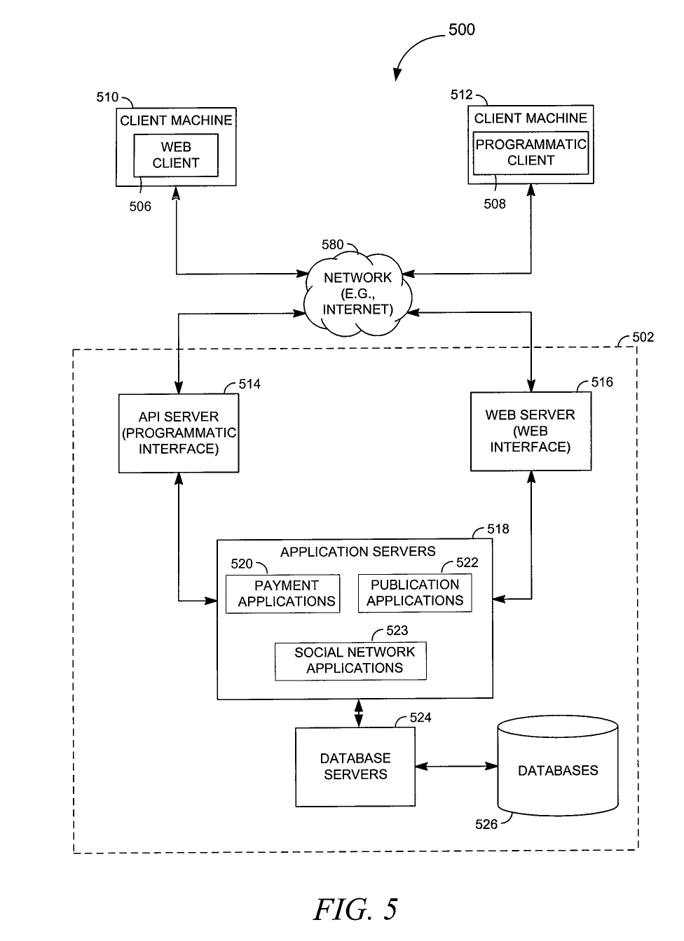

FIG. 5 is high-level block diagram illustrating an example embodiment of a network-based publication system 500, having a client-server architecture, initiating a social group based on historical transaction information. A publication platform, in the example form of networked system 502, may provide server-side functionality, via a network 580 (e.g., the Internet) to one or more clients. FIG. 5 illustrates, for example, a Web client 506 (e.g., a browser, such as the INTERNET EXPLORER browser developed by Microsoft Corporation of Redmond, Wash.), and a programmatic client 508 being executed on respective client machines 510 and 512.

Turning to the networked system 502, an Application Program Interface (API) server 514 and a Web server 516 are coupled to, and provide programmatic and Web interfaces respectively to, one or more application servers 518. The application servers 518 host one or more publication applications 520, payment applications 522, and social network applications 523. The application servers 518 are, in turn, shown to be coupled to one or more database servers 524 that facilitate access to one or more databases 526.

The publication applications 520 may provide a number of publication functions and services to users who access the network-based publication system 500. For example, the publication applications may support posting and browsing listings (e.g., items, services, etc.) in the network-based publication system 500. The payment applications 522 may likewise provide a number of payment services and functions to users. The social network applications 523 may support suggesting new groups associated with a social network; and posting and browsing information related to new groups in a social network, group members, and activities and interests related to group members in the network-based publication system 500.

Further, while the network-based publication system 500 shown in FIG. 5 employs a client-server architecture, the disclosed system is not limited to such an architecture and could equally well find application in a distributed, or peer-to-peer, architecture system. The various publication, payment, and social network applications 520, 522, and 523 could also be implemented as stand-alone software programs, which do not necessarily have networking capabilities.

The Web client 506 may access the publication, payment, and social network applications 520, 522, and 523 via the Web interfaces supported by the Web server 516. Similarly, the programmatic client 508 may access the various services and functions provided by the publication, payment, and social network applications 520, 522, and 523 via the programmatic interfaces provided by the API server 514. The programmatic client 508 may, for example, be a search application to enable buyers to search for listings of interest to the buyers in the network-based publication system 500. In another example embodiment, the programmatic client 508 may facilitate suggesting new groups within a social network; and support users by easing joining new groups and posting of information (e.g., purchased items, items of interest, items sold, activities, coupons, promotional and advertising material, etc.) in the network-based publication system 500.

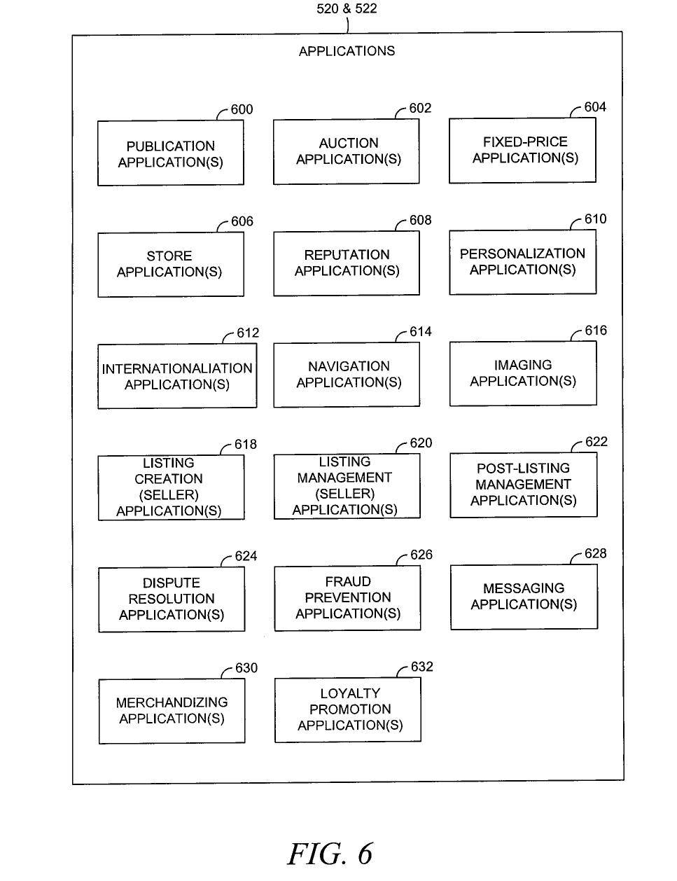

FIG. 6 is an example set of publication and social network applications used by the network-based publication system 500 of FIG. 5. The applications 520 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 526 via the database servers 528.

The networked system 502 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 520 are shown to include at least one publication application 600 and one or more auction applications 602 which support auction-format listing and price setting mechanisms (e.g., English, Dutch, Vickrey, Chinese, Double, Reverse auctions etc.). The various auction applications 602 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 604 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 606 allow a seller to group listings within a “virtual” store, which may be branded and otherwise personalized by and for the seller. Such a virtual store may also offer promotions, incentives and features that are specific and personalized to a relevant seller.

Reputation applications 608 allow users that transact, utilizing the networked system 502, to establish, build and maintain reputations, which may be made available and published to potential trading partners. Consider that where, for example, the networked system 502 supports person-to-person trading, users may otherwise have no history or other reference information whereby the trustworthiness and credibility of potential trading partners may be assessed. The reputation applications 608 allow a user, for example through feedback provided by other transaction partners, to establish a reputation within the networked system 502 over time. Other potential trading partners may then reference such a reputation for the purposes of assessing credibility and trustworthiness.

Personalization applications 610 allow users of the networked system 502 to personalize various aspects of their interactions with the networked system 502. For example a user may, utilizing an appropriate personalization application 610, create a personalized reference page at which information regarding transactions to which the user is (or has been) a party may be viewed. Further, a personalization application 610 may enable a user to personalize listings and other aspects of their interactions with the networked system 502 and other parties.

The networked system 502 may support a number of marketplaces that are customized, for example, for specific geographic regions. A version of the networked system 502 may be customized for the United Kingdom, whereas another version of the networked system 502 may be customized for the United States. Each of these versions may operate as an independent marketplace, or may be customized (or internationalized) presentations of a common underlying marketplace. The networked system 502 may accordingly include a number of internationalization applications 612 that customize information (and/or the presentation of information) by the networked system 502 according to predetermined criteria (e.g., geographic, demographic or marketplace criteria). For example, the internationalization applications 612 may be used to support the customization of information for a number of regional websites that are operated by the networked system 502 and that are accessible via respective web servers 516.

Navigation of the networked system 502 may be facilitated by one or more navigation applications 614. For example, a search application (as an example of a navigation application) may enable key word searches of listings published via the networked system 502. A browse application may allow users to browse various category, catalogue, or inventory data structures according to which listings may be classified within the networked system 502. Various other navigation applications may be provided to supplement the search and browsing applications.

In order to make listings, available via the networked system 502, as visually informing and attractive as possible, the marketplace applications 520 may include one or more imaging applications 616 utilizing which users may upload images for inclusion within listings. An imaging application 616 also operates to incorporate images within viewed listings. The imaging applications 616 may also support one or more promotional features, such as image galleries that are presented to potential buyers. For example, sellers may pay an additional fee to have an image included within a gallery of images for promoted items.

Listing creation applications 618 allow sellers conveniently to author listings pertaining to goods or services that they wish to transact via the networked system 502 and listing management applications 620 allow sellers to manage such listings. Specifically, where a particular seller has authored and/or published a large number of listings, the management of such listings may present a challenge. The listing management applications 620 provide a number of features (e.g., auto-relisting, inventory level monitors, etc.) to assist the seller in managing such listings. One or more post-listing management applications 622 also assist sellers with a number of activities that typically occur post-listing. For example, upon completion of an auction facilitated by one or more auction applications 602, a seller may wish to leave feedback regarding a particular buyer. To this end, a post-listing management application 622 may provide an interface to one or more reputation applications 608, so as to allow the seller conveniently to provide feedback regarding multiple buyers to the reputation applications 608.

Dispute resolution applications 624 provide mechanisms whereby disputes arising between transacting parties may be resolved. For example, the dispute resolution applications 624 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 626 implement fraud detection and prevention mechanisms to reduce the occurrence of fraud within the networked system 502.

Messaging applications 628 are responsible for the generation and delivery of messages to users of the networked system 502, such messages for example advising users regarding the status of listings at the networked system 502 (e.g., providing “outbid” notices to bidders during an auction process or to provide promotional and merchandising information to users). Respective messaging applications 628 may utilize any one have a number of message delivery networks and platforms to deliver messages to users. For example, messaging applications 628 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 630 support various merchandising functions that are made available to sellers to enable sellers to increase sales via the networked system 502. The merchandising applications 80 also operate the various merchandising features that may be invoked by sellers, and may monitor and track the success of merchandising strategies employed by sellers.

The networked system 502 itself, or one or more parties that transact via the networked system 502, may operate loyalty programs that are supported by one or more loyalty/promotions applications 632. For example, a buyer may earn loyalty or promotions points for each transaction established and/or concluded with a particular seller, and be offered a reward for which accumulated loyalty points can be redeemed.

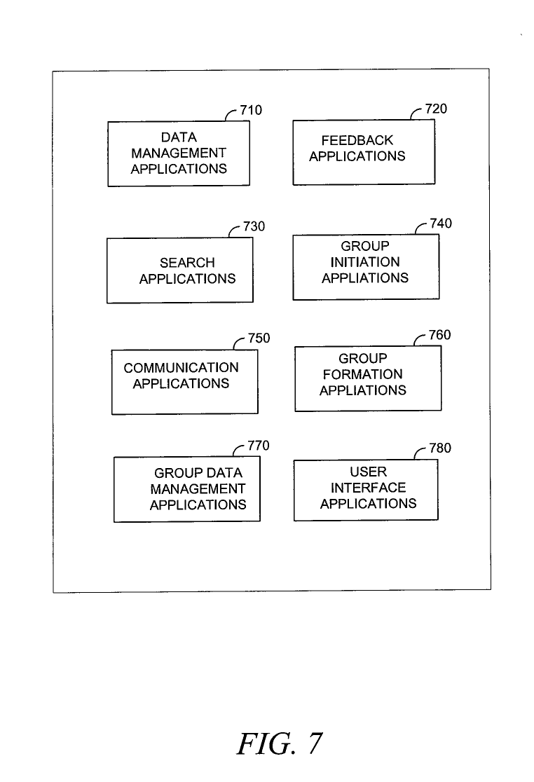

FIG. 7 is an example set of social network applications 523 used by the network-based publication system 500 of FIG. 5. The networked server 502 may provide the social network applications 523 suggesting new groups within a social network and supporting users in joining the new groups and posting information on the network-based publication system 500.

Various data management applications 710 may provide support for handling data, including storing and retrieving data related to various listings published in the network-based publication system 500. The data management applications 710 may facilitate for the listing data to be categorized according to specific categories based on certain keywords.

Feedback applications 720 may support leaving feedback by users of the network-based publication system 500 related to their experiences with other users of the network-based publication system 500. For example the buyer or seller of an item may rate the seller or buyer by leaving feedback (e.g., a positive, or a negative comment) for the seller or buyer of the item. The feedback applications 720 may be used by the network-based publication system 500 in deciding to suggest new groups within the social network. For example, if the feedback applications indicate that a seller is highly popular among buyers, group initiation applications 740 may suggest that a new group (e.g., a suggested group) related to items of the seller or the seller's specialty be formed in the social network.

A number of search applications 730 may support searching the databases 526 of the network-based publication system 500 for data items, using search criteria received from a user of the network-based publication system 500. The group initiation applications 740 may assist in activities resulting in initiation of a new group within the social network. Such activities may include using search applications 730 to examine the databases 526 for a list of popular items (e.g., items that receive a great number of bids or are sold in large numbers, etc.) popular sellers (e.g., sellers popular among the buyers either because of the line of products or their special interests or expertise), and communicating a suggestion about formation of the new group to communication applications 750 or user interface applications 780.

The communication applications 750 may facilitate receiving search criteria from users of the network-based publication system 500. The communication applications 750 may also communicate user interface data including formation of new groups within a social network to the users. The communication applications may also support receiving information from the users including group members related to their activities and interests.

One or more group formation Applications 760 may support formation of new groups within various social networks (e.g., social networks sponsored by a publication system such as eBay Inc. or Kijiji.com). The group formation applications 760 may facilitate efforts by the network-based publication system 500 to promote formation of the new groups and inviting of new members to join the new groups. The group formation applications may also support creating group data structures including group data such as data feeds (e.g., information related to an activity associated with users such as group members).

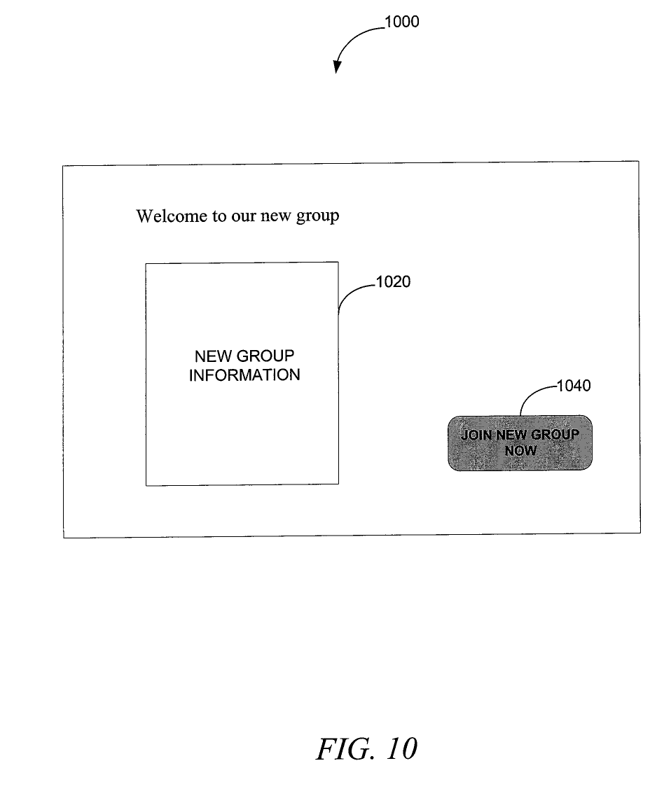

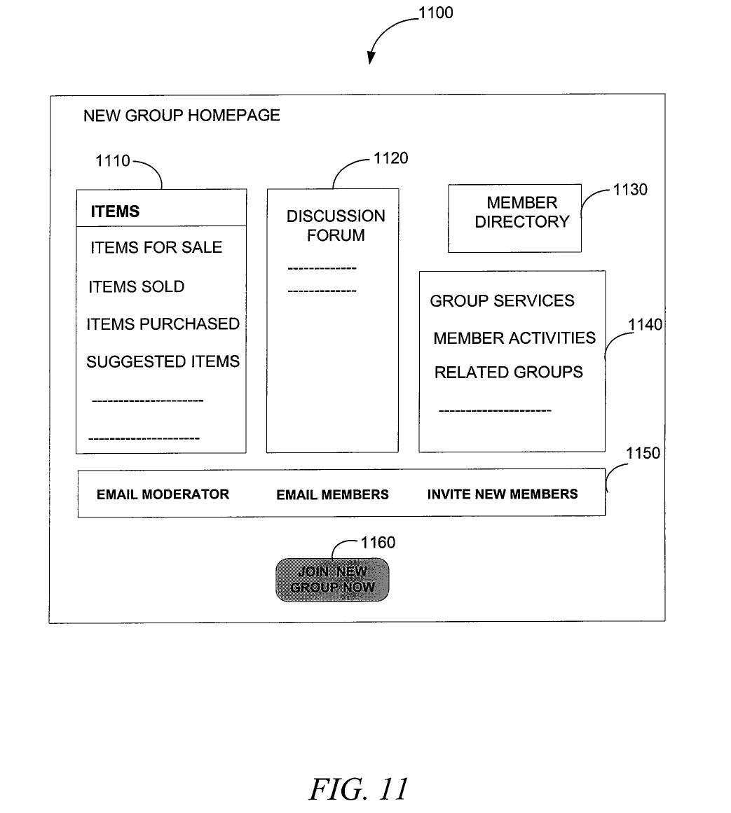

A number of group data management applications 770 may provide support for group initiation applications 740 and group formation applications 750 in retrieving and storing information related to groups associated with one or more social networks. The user interface applications 780 may display various user interfaces (see, for example, FIGS. 10-11) promoting and suggesting formation of new groups associated with a number of social networks and receiving information from the users including group members using the network-based publication system 500. The user interface applications 780 may also display pages whereby users (e.g., group members) may post advertisements for items or services in the network-based publication system 500.

FIG. 8 is a depiction of database schema illustrating, in an example embodiment, various tables of a social network data structure. The group data structures created by the group creation module 230 (see FIG. 2) or group formation applications 870 (see FIG.8), as stored in database 250 (see FIG. 2) or databases 526 (see FIG. 5), may include Group tables 820. The group tables 820 may be parts of higher-level tables such as social network tables 810. Each social network may include a number of groups, and group data for each group may be stored in group table 820. Each group table 820 may include a number of tables. In an example embodiment, the group table 820 may include, but is not limited to, a members table 825, a member activities table 830, a service table 835, a related group tables 840, an items for sale table 845, an items wanted table 850, an items bought table 855, and an item suggested table 860.

The members table 825 may include information related to the group members. The information may include group members identifications (e.g., name, telephone number, email address, etc.). The group creation module 230 (see FIG. 2) may generate a member directory and store it on table 825. The group creation module may also store group member activities in member activities table 830. The group member activities may include, for example, a speech in a seminar or a meet-up sponsored by the group member, for which information such as a topic, a place, a date and a time may be stored in the member activities table 830.

Information on one or more services provided by the group members may be stored in the services table 835. The services may be professional services or volunteer services. Some of the services may be provided specifically for the group members. For example, a group member may volunteer to provide free expert opinion on certain matters to group members. The related groups table 840 may store information related to other groups or neighborhoods that the group members are a member of or may have other links to them.

The items for sale table 845 may include information on items that are available for sale from the group members. The items for sale may be items that a group member has listed in a publication system. Group members may also provide information related to items that they are interested in buying (e.g., items wanted); the information may be stored in the items wanted table 850. The items bought table 855 may include data related to items that have been purchased (e.g., using the publication system) by one or more group members. Information related to suggested items for group members to consider buying are stored in the items suggested table 860.

### Machine Architecture

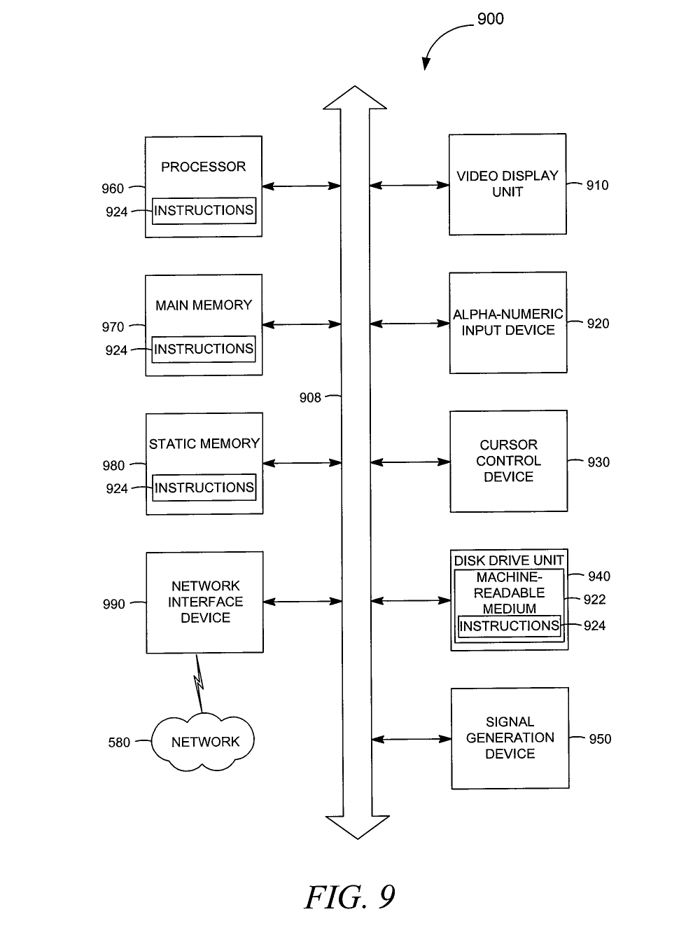

FIG. 9 is a diagram illustrating a diagrammatic representation of a machine 900 in the example form of a computer system, within which a set of instructions for causing the machine to perform any one or more of the methodologies discussed herein may be executed. In alternative embodiments, the machine 900 may operate as a standalone device or may be connected (e.g., networked) to other machines. In a networked deployment, the machine 900 may operate in the capacity of a server or a client machine in a server-client network environment, or as a peer machine in a peer-to-peer (or distributed) network environment.

The machine 900 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 may include a processor 960 (e.g., a central processing unit (CPU), a graphics processing unit (GPU) or both), a main memory 970 and a static memory 980, all of which communicate with each other via a bus 908. The computer system 900 may further include a video display unit 910 (e.g., a liquid crystal display (LCD) or cathode ray tube (CRT)). The computer system 900 also may include an alphanumeric input device 920 (e.g., a keyboard), a cursor control device 930 (e.g., a mouse), a disk drive unit 940, a signal generation device 950 (e.g., a speaker) and a network interface device 990.

The disk drive unit 940 may include a machine-readable medium 922 on which is stored one or more sets of instructions (e.g., software 924) embodying any one or more of the methodologies or functions described herein. The software 924 may also reside, completely or at least partially, within the main memory 970 and/or within the processor 960 during execution thereof by the computer system 900, with the main memory 970 and the processor 960 also constituting machine-readable media. The software 924 may further be transmitted or received over a network 580 via the network interface device 990.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. The term “machine-readable medium” shall accordingly be taken to include, but not be limited to, solid-state memories and optical and magnetic media.

### User Interfaces

FIG. 10 is a screen shot illustrating an example embodiment of a user interface 1000 used for initiating a social group based on historical transaction information. The user interface 1000 may include a portion 1020 including basic information related to the new group. The new group may be automatically initiated by the group initiation module 220, based on historical transaction information (e.g., information related to listings in a commerce system, such as a number of sold listings, a number of bids placed for each listing, feedbacks, etc.). The basic information may include a group name, date of initiation, and a subject, a category, or person's name that the group may be associated with. For example, the group may be associated with a subject (e.g., ice skating, new energies, etc.), or a category (e.g., cars, computers, etc.) or a person who has somehow become popular among the users of a publication system, for example a best seller of the month (e.g., a seller with highest positive feedback, etc.)

The user interface 1000 may also include a button 1040 for interested users to click to join the new group. Clicking on the button 1040 may lead the user to a new page where the user may be asked to enter identification information, select user credentials and answer certain questions.

FIG. 11 is a screen shot illustrating an example embodiment of a user interface 1100 showing home page of a social group initiated based on historical transaction information. The user interface 1100 may include an items window 1110, where listing information related to group members, such as items for sale, items sold, items purchased or items suggested, by the group members (e.g., in a publication system, such as eBay, Inc., or Kijiji.com, etc.) will be displayed. The user interface 1100 may provide a discussion forum portion 1120, where users may discuss issues of mutual interest (e.g., regarding, items, transactions, etc.). The users may find a list of group members including group members' identification information in the member directory box 1130.

In an example embodiment, the user interface 1100 may also display information including group services (e.g., services provided by the group members, such as professional or volunteer services), member activities (e.g., a list of activities by group members, including holding meet-ups, sponsoring seminars, etc.), and a list of related groups or neighborhoods in a portion 1140. The users may be allowed to email a group moderator or other group members or invite new members by activating (e.g., using a mouse to click on) respective links provided in box 1150. A button 1160, allows an interested user to join the group by activating the button 1160.

Thus, a method and a system for initiating a social group based on historical transaction information have been described. Although the present subject matter has been described with reference to specific example embodiments, it will be evident that various modifications and changes may be made to these embodiments without departing from the broader spirit and scope of the subject matter. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computerized method comprising:
creating a user interface associated with a social network;
automatically suggesting, via the user interface, formation of a group within the social network, wherein the automatically suggesting includes suggesting based on historical transaction information;
receiving, via the user interface, a response from at least one user, the response indicating that the at least one user is interested in the group; and
responsive the receiving of the response, automatically creating a group data structure including group data.

2. The method of claim 1, wherein the social network is associated with an online publication system.

3. The method of claim 1, wherein the historical transaction information includes information related to a listing in an online publication system.

4. The method of claim 3, wherein the historical transaction information includes a popularity factor associated with the listing in the online publication system.

5. The method of claim 1, further including receiving information related to the group from users and storing the information in the group data structure.

6. The method of claim 4, further including determining the popularity factor, using data related to the listing including at least one of:
a number of bids,
a number of completed transactions;
a number of views received by the listing;
a number of searches associated with the listing;
a number of expressed interests in the listing; or feedback.

7. The method of claim 1, further including presenting the group data to the users.

8. The method of claim 1, further including communicating a message to the users, the message including an invitation to join the group.

9. The method of claim 1, wherein the group data includes data feeds, the data feeds including information related to an activity associated with a group member.

10. The method of claim 9, further including providing member alerts advising the users with respect to the activity.

11. The method of claim 9, wherein the data feeds include at least one of:
a suggestion by at least one group member, or
a shopping or trading story shared by at least one group member.

12. The method of claim 11 wherein the suggestion by the group member relates to at least one of:
a formation of a new group; or
an invitation to a new group member.

13. The method of claim 1, wherein the group data includes information related to services provided by the group.

14. The method of claim 13, wherein the services include an expert opinion.

15. A system comprising:
a user interface module to create a user interface associated with a social network;
a group initiation module to automatically suggest, via the user interface, formation of a group within the social network, based on transaction information;
a communication module to receive, via the user interface, a response from at least one user, the response indicating that the at least one user is interested in the group; and
responsive to the receiving of the response, a group creation module to automatically create a group data structure including group data.
the communication module to receive information related to the group from users; and
a database server to store the information in the group data structure.

16. The system of claim 15, wherein the group initiation module is to automatically suggest the formation of the group within the social network based on the historical transaction information including information related to a listing in an online publication system.

17. The system of claim 16, wherein the historical transaction information includes a popularity factor associated with the listing in the online publication system.

18. The system of claim 15, wherein the communication module is to receive information related to the group from users; and further including a database server to store the information in the group data structure.

19. The system of claim 17, further including a processor to determine the popularity factor using data related to the listing including at least one of:
a number of bids;
a number of completed transactions;
a number of views received by the listing;
a number of searches associated with the listing;
a number of expressed interests in the listing; or feedback.

20. The system of claim 15, wherein the user interface is to present group data to the users, the group data including data feeds, the data feeds including information related to an activity associated with a group member.

21. The system of claim 15, wherein the communication module is to communicate a message to the users, the message including an invitation to join the group.

22. The system of claim 20, wherein the user interface is to provide member alerts advising the users with respect to activities associated with the group member.

23. The system of claim 20, wherein the data feeds include at least one of:
a suggestion by at least one group member including at least one of:
a formation of a new group, or inviting a new group member; or
a shopping or trading story shared by at least one group member.

24. A system comprising:
means for creating a user interface associated with a social network;
means for automatically suggesting, via the user interface, formation of a group within the social network, wherein the automatically suggesting includes suggesting based on historical transaction information;
means for receiving, via the user interface, a response from at least one user,
the response indicating that the at least one user is interested in the group; and
means for responsive to the receiving of the response, automatically creating a group data structure including group data.

25. A machine-readable medium comprising instructions, which when executed by one or more processors perform the following operations:
creating a user interface associated with a social network;
automatically suggesting, via the user interface, formation of a group within the social network, wherein the automatically suggesting includes suggesting based on historical transaction information;
receiving, via the user interface, a response from at least one user, the response indicating that the at least one user is interested in the group; and
responsive to the receiving of the response, automatically creating a group data structure including group data.
